(19) United States
(12) Patent Application Publication
(10) Pub. No.: US 2007/0014942 A1
(43) Pub. Date: Jan. 18, 2007

(54) MATERIAL AND MANUFACTURING METHOD THEREOF

(76) Inventor: CHRISTIAN V NICHOLAS, HARROW, MIDDLESEX (GB)

Correspondence Address: PATENT LEGAL STAFF, EASTMAN KODAK COMPANY, 343 STATE STREET, ROCHESTER, NY, 14650-2201, US

(21) Appl. No.: 10/544,298

(22) PCT Filed: Jan. 21, 2004
(86) PCT No.: PCT/GB04/00191

§ 371 Date: Aug. 21, 2006

(30) Foreign Application Priority Data
Feb. 7, 2003 (GB) 0302790.1

(51) Int. Cl. B41M 5/00

(52) U.S. Cl. 428/32.34

(57) ABSTRACT

The invention provides a method of making a material for use as an inkjet receiver and a material made by the method. The method comprises the steps of coating a support layer with a thermoresponsive gel, the gel having hydrophilic particulate material dispersed therein. The thermoresponsive gel is controlled to be at a temperature below its threshold switching temperature. The method then comprises the step of providing heat to the thermoresponsive gel thereby causing the gel to switch states.

The present invention relates to a material suitable for use as an inkjet receiver and to a method of manufacturing the material. In particular the invention relates to a method of manufacturing a material having enhanced absorption capacity.

### BACKGROUND OF THE INVENTION

Most commercial photo-quality inkjet receivers can be classified in one of two categories according to whether the principal component material forms a layer that is porous or non-porous in nature. Inkjet receivers having a porous layer are typically formed of inorganic materials with a polymeric binder. When ink is applied to the receiver it is absorbed quickly into the porous layer by capillary action. However, the open nature of the layer can contribute to instability of printed images.

Inkjet receivers having a non-porous layer are typically formed by the coating of one or more polymeric layers onto a support. When ink is applied to such receivers, the polymeric layers swell and absorb the applied ink. However, due to limitations of the swelling mechanism, this type of receiver is slow to absorb the ink, but once dry, printed images are often stable when subjected to light and ozone. When ink is printed on a receiver that is slow to absorb ink, the drying time of the receiver can be extended. Furthermore, such receivers may have inadequate absorption capacity for ink. This is clearly undesirable.

U.S. Pat. No. 5,439,739 in the name of Mitsubishi Paper Mills Limited discloses an ink jet recording medium capable of providing water resistant recorded images. The material is formed by coating on a support a solution of 100 parts by weight of a water-soluble polymer and 0.1 to 30 parts by weight of a crosslinking agent such as an epoxy crosslinking agent.

### PROBLEM TO BE SOLVED BY THE INVENTION

A material for use as an inkjet receiver is desired that does not suffer from the problem of inadequate absorption capacity of ink. A material is also desired that combines the properties of light and ozone stability usually associated with non-porous receivers with good ink-absorption usually associated with porous inkjet receivers. A method of making such a material is also desired.

### SUMMARY OF THE INVENTION

According to a first aspect of the present invention, there is provided a method of making a material. The method comprises the steps of coating a support layer with a thermoresponsive gel having particulate material suspended therein, the thermoresponsive gel being controlled to be at a temperature below its threshold switching temperature and, providing heat to the thermoresponsive gel thereby causing the thermoresponsive gel to switch states.

According to a second aspect of the present invention, there is provided a material for use as an inkjet receiver, the material comprising a support layer and an ink receiver layer. The ink receiver layer comprises a porous layer of thermo responsive material.

### ADVANTAGEOUS EFFECT OF THE INVENTION

The invention provides a material and a method of making a material in which the temperature of a thermoresponsive gel is controlled to change from below its switch temperature to above it. This causes a reduction in the volume of the thermoresponsive gel such that voids are generated in the material due to the particulate material suspended within it.

The invention provides a material for use as an ink jet receiver that combines the properties of light and ozone stability associated with non-porous receivers with the property of good ink absorption associated with porous receivers. The invention also provides a simple and robust method for manufacturing a material suitable for use an ink jet receiver. The material can be manufactured using conventional coating systems.

Since the material has good ink absorption, the drying time of ink printed onto the material is improved.

### BRIEF DESCRIPTION OF THE DRAWINGS

Examples of the present invention will now be described in detail with reference to the accompanying drawings, in which:

FIG. 1 shows a schematic representation of part of an intermediate product in the preparation of an inkjet receiver according to the present invention;

FIG. 2 shows a schematic representation of an inkjet receiver according to the present invention;

FIGS. 3 and 4 show scanning electron micrographs of sections through conventional inkjet receivers;

FIGS. 5 and 6 show scanning electron micrographs of sections through inkjet receivers according to the present invention; and,

FIG. 7 is a bar chart showing densitometry results from a number of materials demonstrating the advantage of the present invention.

### DETAILED DESCRIPTION OF THE INVENTION

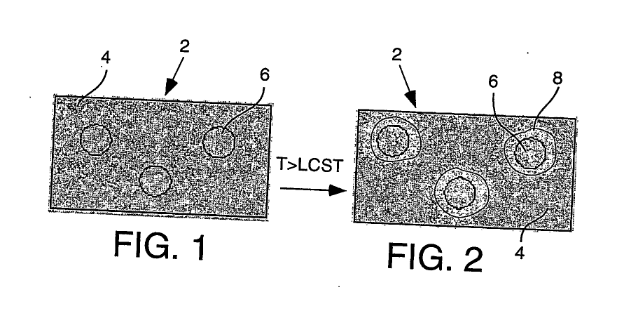

FIG. 1 shows a schematic representation of a layer in an intermediate product in the preparation of an inkjet receiver according to the present invention. The layer 2 is made up of an aqueous solution of a thermoresponsive gel 4 interspersed with hydrophilic particulate matter 6 i.e. particulate matter that has an outer surface with hydrophilic properties so that interaction with any surrounding material is as hydrophilic material. The particulate matter is suspended in the aqueous solution of thermoresponsive gel 4. Thermoresponsive gels are known to change from being hydrophilic to hydrophobic in dependence on their temperature. In particular there is a threshold or switching temperature, the Lower Critical Solution Temperature LCST, at which the thermoresponsive gel switches from one state to the other. In FIG. 1 the layer 2 is below the LCST and so the gel 4 maintains hydrophilic characteristics.

FIG. 2 shows a schematic representation of the same layer after the temperature has been raised above the gel's LCST. The gel has switched state to become hydrophobic. In molecular terms, the polymer chains that makes up the gel 4 undergo a transition from a coil to a globule, decreasing the free volume of the gel. The decrease in volume of the gel causes it to recede from the particles 6 dispersed within it, so generating voids 8 in the layer 2. If the particles used are selected so that they have hydrophilic outer surfaces, the accompanying hydrophilic-to-hydrophobic switch of the gel at the LCST renders the surfaces created around the voids incompatible with the particles 6, thus discouraging closure of the voids. A stable porous material is formed. The material is suitable for any use in which a porous receiver is desired such as use as an inkjet receiver.

During manufacture, an aqueous layer of a coating solution comprising a thermoresponsive gel and suitably sized particles is coated onto a material support. The support may be any type of support on which it is desired to create an inkjet receiver. Examples of types of material from which the support may be made, include amongst others paper, resin-coated paper and polyethylene terephthalate. The aqueous layer is coated using any suitable coating method. Examples, include bead coating, curtain coating and air-knife coating. When the aqueous layer is coated onto the support the solution is maintained at a temperature below the LCST of the gel. Once coated onto the support, the temperature of the solution is raised so that it reaches or exceeds the LCST causing a switch in state of the gel as described above.

An example of a suitable thermoresponsive gel is poly(N-isopropylacrylamide) (pNIPAM), which has an LCST of approximately 32±0.5° C. The LCST can be changed by modifying the polymer composition of the polymer pNIPAM. This applies whichever suitable thermoresponsive gel is used. For example, acrylamide units added to the pNIPAM will increase its LCST. Other examples of suitable thermo responsive gels include polymers of N-isopropyl acrylamide or copolymers of N-isopropyl with acrylamide, alkyl acrylamides, methacrylamide and alkyl methacrylamides.

The suitably sized particles used in the coating solution are preferably selected such that they have hydrophilic outer surfaces. As well as encouraging a uniform distribution within the coating solution prior to coating, this has the additional advantage that closure of the created in the coated layer is discouraged since the accompanying hydrophilic-to-hydrophobic switch of the gel at the LCST renders the surfaces created around the voids incompatible with the particles 6. The porous material is therefore stable.

The particles may be made of a single material or alternatively may have a core surrounded by an outer coating of a different material. As mentioned above it is preferable that the outer coating i.e. the surface of the particles that is exposed to the gel in the aqueous layer is hydrophilic. Examples of suitable material from which the cores of the particles may be made include materials selected from the group consisting of polymers and copolymers of acrylic acid esters and methacrylic acid esters, or polyvinyl benzene containing copolymers. Examples of suitable material from which the outer coating layer of the particles is made includes polymers and copolymers of acrylic acid, methacrylic acid, maleic acid, sodium styrene sulphonate, 2-acrylamido-2-methyl propane sulphonic acid, acrylamide, N-isopropyl acrylamide, ethylene glycol acrylates, ethylene glycol methacrylates and mixtures of these materials.

### EXAMPLE

An example of the present invention will now be described in detailed:

A thermoresponsive gel, namely poly(N-isopropylacrylamide-co-N,N-dimethylacrylamide)(19:1)-poly(NIPAM-co-DMAM)(19:1)—was prepared by solution polymerisation in water, using a redox initiating system comprising ammonium persulphate and sodium metabisulphite. The monomer ratio in the copolymer gel was confirmed by nuclear magnetic resonance. In the copolymer, the thermoresponsive character derives from the predominant NIPAM monomer unit. DMAM, the minor component, was included to lower the glass transition temperature of the gel and so improve its film forming and coating properties.

Molecular weight was evaluated by size exclusion chromatography (SEC); Mw was ca 100,000 (poly(ethylene oxide) equivalents) and the polydispersity was 3.5. Polymer samples were freeze-dried directly after polymerisation and were stored as powders prior to coating.

A 50 wt. % aqueous solution of polyacrylamide (Aldrich, Mw=10,000) was used in place of poly(NIPAM-co-DMAM) in the formulation of non-thermoresponsive coatings for control experiments.

The particles used were “core-shell” latex particles, and comprised a poly styrene (PS) homopolymer core and a poly(styrene-co-methacrylic acid)(1:1)-p(S-co-MA)( 1:1)-copolymer shell. They were synthesised by free radical aqueous emulsion polymerisation at 80° C., initiated with potassium persulphate with sodium dodecyl sulphate as surfactant. The core region was constructed in a batch process, the shell region being grown upon the core in a subsequent semicontinuous process.

NMR analysis revealed that the core:shell ratio obtained experimentally was 70:30. The purpose of the core-shell structure was to confer hydrophilic character upon the particle surface. 100% PS latex particles, possessing hydrophobic surfaces, were also prepared, by a variation of the batch method used to construct the core, such that the final diameter of these particles was approximately equal to that of the core-shell particles.

These PS particles were made for inclusion in control coatings for comparative purposes. Particle size distributions for all samples were evaluated using a Zetasizer 3000 HS, manufactured by Malvern Instruments Ltd., although any suitable particle sizer could have been used. In every case, particles selected for use in the coating were monodisperse and had a mean particle diameter of between about 35 mm and 55 nm, preferably approximately 45 nm.

Latex samples were freeze-dried directly after polymerisation and were stored as powders prior to coating.

The coating equipment used consisted of a metal bench equipped with a water cooling and heating system and a vacuum air flow on the bench upper surface. The aim of the vacuum was to keep the support to be coated, in this case an acetate support, in contact with the bench during drying of the coating. The coating method comprised the steps of deposing dispersion, i.e. the preparations described below, on the acetate support as the system was maintained at a constant temperature (25° C.). A spreading member such as a gravure bar was used to dispense the dispersion homogeneously on the length of the support and, at the same time, to control the layer thickness and surface. Any suitable mechanical arrangement could be used to control the layer thickness and surface.

Two thickness values of the coating layer of dispersion were used depending on the total polymer concentration in the aqueous solution. At 15 wt. % of solids, the volume surface was fixed to 60 ml.m⁻²; at 30,26 and 25 wt. % of solids, it was fixed to 36 ml.m⁻². The use of a translucent support such as cellulose acetate permits visual observation of material “switches”, the coatings becoming white and opaque when the temperature was raised above the LCST of pNIPAM. When such a coating was nearly dried, the material became translucent again.

The coating was then allowed to stabilise for five minutes at the drying temperature. Three values of drying temperature were investigated: 60° C. and 40° C.—above the LCST of pNIPAM—and 25° C.—below LCST. The procedure adopted was to switch (i.e. provide heat so that temperature of the coated layer rose above the LCST), the coated material instantly after coating but, for comparison, four pNIPAM coatings were made in which the moment of switching during drying was varied.

Preparations for coating were made up by mixing PS and poly(NIPAM-co-DMAM) powders with water. The poly(NIPAM-co-DMAM) powder dissolved creating an aqueous polymer solution, PS beads being suspended therein. The relative proportions of PS beads and poly(NIPAM-co-DMAM) used in the preparations are summarised in Table 1, below. Preparations A, B1-3, C and D are mixtures of pNIPAM gel and PS beads with a ratio 60:40 matrix:beads. Preparation B3 is similar in composition to preparation B2 but was made using a pNIPAM solution in water instead of a powder.

Two polymer concentrations were initially investigated, viz. 15 and 30 wt. % solids, but experimental difficulties in making good dispersions resulted in concentrations of 25 and 26 wt. % solids being examined. Preparation E is a dispersion of pNIPAM in water without incorporation of any beads.

TABLE 1
Composition of dispersions.

| | Solid conc. | Matrix/Beads | |
|---|---|---|---|
| Preparation | (wt. %) | ratio | Beads type |
| A | 30 | 60/40 | Hydrophobic |
| B1 | 15 | | Hydrophobic |
| B2 | 15 | | Hydrophilic |
| B3 | 15 | | Hydrophilic |
| C | 26 | | Hydrophobic |
| D | 25 | | Hydrophilic |
| E | 15 | 100/0 | N/A |

A sample of material was made in a run using each of eighteen different sets of experimental conditions. The experimental conditions included the composition of the coating solution i.e. preparation, the volume (or thickness) of the layer applied, the temperature at which the sample was dried and moment of switching during drying.

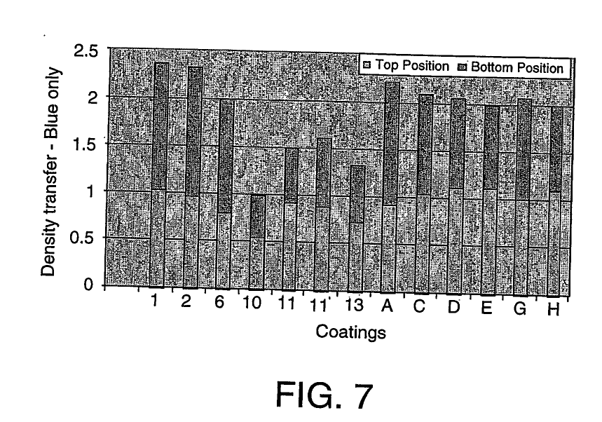

Coating solutions used in sixteen of the eighteen runs comprised pNIPAM in addition to particulate material e.g. beads or particles, of some description. Coating solutions used in the remaining two runs comprised only pNIPAM. Details of the coating solutions used in each of the eighteen runs are summarised in tables 2 and 3 below. The materials made in runs 9A-D were prepared using preparation A with variation of the moment of switching during drying. No delay before switching was applied for all the other runs. Three solutions of a non-thermoresponsive gel (polyacrylamide) were also made up and a number of control materials were made using these solutions. The control materials are referred to below in FIG. 7 as materials A, C, D, E, G and H.

TABLE 2
Coatings.

| | | Vol. Surf. | Drying T |
|---|---|---|---|
| Run | Preparation | (ml · m − 2) | (° C.) |
| 1 | A | 36 | 60 |
| 3B | | | 40 |
| 6 | | | 25 |
| 2 | B1 | 60 | 60 |
| 4 | | | 40 |
| 5 | | | 25 |
| 11 | B2 | 60 | 60 |
| 13 | | | 40 |
| 11′ | B3 | 60 | 40 |
| 3A | C | 36 | 60 |
| 10 | D | 36 | 60 |
| 12 | | | 40 |
| 7A | E | 60 | 60 |
| 7B | | | 40 |

TABLE 3
Coatings.

| | | Vol. Surf. | Lapse Time at | Drying T |
|---|---|---|---|---|
| Run | Preparation | (ml · m − 2) | 23° C. (min) | (° C.) |
| 9A | A | 36 | 1.5 | 60 |
| 9B | | | 3 | |
| 9C | | | 6 | |
| 9D | | | 12 | |

Once all the materials had been prepared using each of the preparations or set of experimental conditions, Scanning Electron Microscopy (SEM) analysis was used to determine the qualities of the material. The materials were prepared for SEM analysis. An area of the material was cut out and freeze fractured using liquid nitrogen. The fractured section was mounted vertically on a numbered aluminium SEM stub using an adhesive carbon tab with the fractured surface uppermost. Silver dag was applied to lower edge of the sample, away from the fractured surface, to increase electrical conductivity and aid support of the sample. The sample was coated with Au in a sputter coater for 20 seconds. The fractured face of the coating, which corresponded to a cross section of the inkjet layer, was then examined in a Philips XL30S FEG SEM. Images were taken within 4 hours of the samples being prepared.

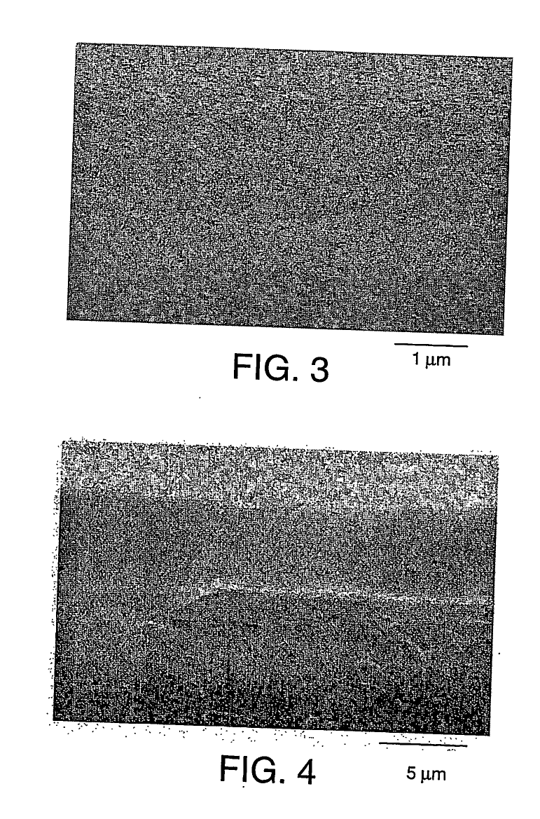

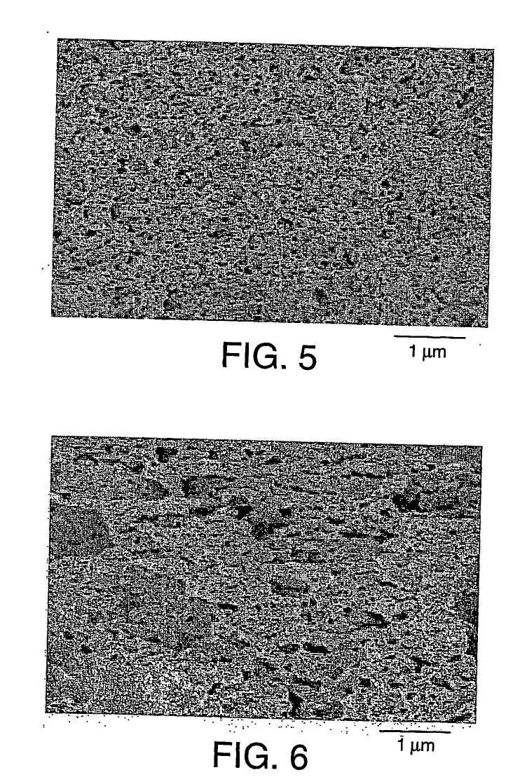

FIGS. 3 to 6 show examples of the images obtained from the SEM analysis. FIG. 3 shows a section through the material made using a coating solution which was a polyAM gel with poly(S-co-MA) beads. An unvoided material is formed. FIG. 4 shows a section through the material made using a coating solution which was all-pNIPAM. Again an unvoided material is formed. FIGS. 5 and 6 show sections through materials each made of a pNIPAM gel with poly(S-co-MA) beads. In both cases, a voided material is formed.

A number of the prepared materials were then tested for their performance in terms of ink transfer after printing. The test consisted of printing on the material a drawing made of seven successive bands, each band being a different colour: black, cyan, magenta, yellow, red, green and blue. The printer used was an Epson 870. As soon as the printing was finished, a sheet of white paper was put on the surface of the printed area and a roller passed twice over the coating-paper system.

The paper was then separated from the material, and the density of ink transferred from the material to the paper was evaluated using a conventional densitometer. The colour transferred at the bottom and top position of each band was measured. Since printing of the bands takes a predetermined length of time, ink at one end of the band has a different amount of time to dry than ink at the other end. The density values of transferred ink were resolved into three components of the visible spectrum—red, green and blue—and an average density value was deduced.

The following materials were tested for ink transfer:
1. (Referring to table 2) Those made by runs 1, 2, 6 (PNIPAM with hydrophobic beads);
2. (Referring to table 2) Those made by runs 10, 11 and 11′, 13 and 13′ (PNIPAM with the hydrophilic beads);
3. Control materials A, C, D, E, G and H i.e. those made using a polyAM coating solution.

Referring only to blue density, the results of the ink transfer tests are shown in FIG. 7. Control materials A, C, D, E, G and H, and those made by runs 1, 2 and 6, (pNIPAM with hydrophobic beads), give approximately the same density transfer: between 2 and 2.5 at the bottom position and between 0.8 and 1.2 at the top position. Thus, no improvement in ink absorption capacity of the materials is observed with the voided structures in comparison to the non-voided structures. The same trend is observed when looking at colours other than blue.

This can be explained by an incompatibility between the hydrophobic beads and the ink water-solution. In contrast, the materials made by runs 10, 11, 11′ and 13, which are pNIPAM coatings with the hydrophilic beads, have lower ink density transfer values than the other samples and this effect is greater at the bottom position than at the top position. Values are between 1 and 1.5 at the bottom position and between 0.5 and 0.9 at the top position. This demonstrates that the hydrophilic character of the particles is a factor in ink absorption and that voids improve ink absorption. The tests were repeated for new and old materials. Old materials were materials that had been made and stored for one or two weeks, whereas new materials were those made and tested on the same day. No differences were observed between fresh and old coatings, demonstrating that the switching and shrinking of the pNIPAM does not reverse with time, so that the voids persist and the coated layer remains porous.

1. A method of in making a material for use as an inkjet receiver, the method comprising the steps of:
coating a support layer with a thermoresponsive gel, the gel having hydrophilic particulate material dispersed therein, the thermoresponsive gel being controlled to be at a temperature below its threshold switching temperature;
providing heat to the thermoresponsive gel thereby causing said thermoresponsive gel to switch states.

2. A method according to claim 1, in which the thermoresponsive gel is a gel selected from the group consisting of polymers of N-isopropyl acrylamide or copolymers of N-isopropyl with acrylamide, alkyl acrylamides, methacrylamide and alkyl methacrylamides.

3. A method according to claim 1 in which the particles of material have a hydrophilic outer surface and in which prior to switching, the thermoresponsive gel is in its hydrophilic state.

4. A method according to claim 3, in which the particles of material are made of a uniform material.

5. A method according to claim 3, in which the particles of material have core made of a first material and an outer coating layer, the outer coating layer being made of a hydrophilic material.

6. A method according to claim 5, in which the cores of the particles are made of a material selected from the group consisting of polymers and copolymers of acrylic acid esters and methacrylic acid esters, or polyvinyl benzene containing copolymers.

7. A method according to claim 5, in which the outer coating layer of the particles is made of a material selected from the group consisting of polymers and copolymers of acrylic acid, methacrylic acid, maleic acid, sodium styrene sulphonate, 2-acrylamido-2-methyl propane sulphonic acid, acrylamide, N-isopropyl acrylamide, ethylene glycol acrylates, ethylene glycol methacrylates and mixtures of these materials.

8. A method according to claim 1, in which the thermoresponsive gel is provided in an aqueous solution thereof.

9. A material for use as an inkjet receiver, comprising:
a support layer;
an ink receiver layer, the ink receiver layer comprising a porous layer of thermo responsive material.

10. A material according to claim 9, in which the thermoresponsive gel is a gel selected from the group consisting of polymers of N-isopropyl acrylamide or copolymers of N-isopropyl with acrylamide, alkyl acrylamides, methacrylamide and alkyl methacrylamides.

11. A material according to claim 10, in which the thermoresponsive material includes particles of a material, the particles having a hydrophilic outer surface.

12. A material according to claim 11, in which the particles comprise a core made of a first material and an outer coating made of a second different material, the second different material being hydrophilic.

13. A material according to claim 12, in which the core is made of a material selected from the group consisting of polymers and copolymers of acrylic acid esters and methacrylic acid esters, or polyvinyl benzene containing copolymers.

14. A material according to claim 12, in which the second different material is a material selected from the group consisting of polymers and copolymers of acrylic acid, methacrylic acid, maleic acid, sodium styrene sulphonate, 2-acrylamido-2-methyl propane sulphonic acid, acrylamide, N-isopropyl acrylamide, ethylene glycol acrylates, ethylene glycol methacrylates and mixtures of these materials.
